(19) United States
(12) Patent Application Publication
(10) Pub. No.: US 2015/0132735 A1
(43) Pub. Date: May 14, 2015

(54) PRESENTATION REHEARSAL

(71) Applicant: Microsoft Corporation, Redmond, WA (US)

(72) Inventors: Darren Keith Edge, Beijing (CN); Ha Thu Trinh, Hanoi (VN)

(73) Assignee: Microsoft Corporation, Redmond, WA (US)

(21) Appl. No.: 14/077,674

(22) Filed: Nov. 12, 2013

(51) Int. Cl. G09B 5/02; G09B 5/06

(52) U.S. Cl. CPC G09B 5/02; G09B 5/06
USPC 434/308; 434/365

(57) ABSTRACT

Some implementations may include a computing device to generate a presentation and enable rehearsing delivery of the presentation. The presentation may include multiple slides, with each slide having one or more visual elements, such as text or graphics. One or more notes sections may be created. Each of the one or notes sections may correspond to a visual element of the one or more visual elements. Time targets associated with each of the one or more visual elements may be received. During rehearsal, visual elements may be highlighted based on the time targets and/or a position of the visual elements on a slide may be identified based on the time targets.

### BACKGROUND

After completing a draft of presentation media (e.g., PowerPoint® slides), a presenter may not be sufficiently prepared to provide a full, fluent, timely, spoken rehearsal of the intended delivery. However, attempting to perform a timed and recorded rehearsal of the presentation without being ready may cause a user additional pressure and stress on top of any existing anxiety towards public speaking, leading to rehearsal avoidance and poor-quality presentation delivery.

### SUMMARY

This Summary is provided to introduce a selection of concepts in a simplified form that are further described below in the Detailed Description. This Summary is not intended to identify key or essential features of the claimed subject matter; nor is it to be used for determining or limiting the scope of the claimed subject matter.

Some implementations may include a computing device to generate and rehearse delivering a presentation. The presentation may include multiple slides, with each slide having one or more visual elements, such as text or graphics. One or more notes sections may be created. Each of the one or notes sections may correspond to a visual element of the one or more visual elements. Time targets associated with each of the one or more visual elements may be received. During rehearsal, a visual element may be highlighted and/or a position of the visual element on a slide may be identified to cue recall of the corresponding notes.

### BRIEF DESCRIPTION OF THE DRAWINGS

The detailed description is described with reference to the accompanying figures. In the figures, the left-most digit(s) of a reference number identifies the figure in which the reference number first appears. The same reference numbers in different figures indicate similar or identical items.

FIG. 1 is an illustrative architecture to create and rehearse a presentation according to some implementations.

FIG. 2 is an illustrative architecture to display and rehearse a presentation according to some implementations.

FIG. 3 is a flow diagram of an example process that includes targeted rehearsal according to some implementations.

FIG. 4 is a flow diagram of an example process that includes extended authoring according to some implementations.

FIG. 5 is a flow diagram of an example process that includes note rehearsal according to some implementations.

FIG. 6 is a flow diagram of an example process that includes flow path rehearsal according to some implementations.

FIG. 7 is a flow diagram of an example process that includes compressing and/or expanding notes according to some implementations.

FIG. 8 is a flow diagram of an example process that includes timed speech rehearsal according to some implementations.

FIG. 9 illustrates an example configuration of a computing device and environment that can be used to implement the modules and functions described herein.

### DETAILED DESCRIPTION

The technical problem is how to provide a user, who has created a presentation, with tools to repeatedly rehearse delivering the presentation until the user can deliver the presentation smoothly, without looking at any notes, and within an allotted time. The systems and techniques described herein solve this technical problem by enabling the user to perform extended authoring and timed rehearsals.

The systems and techniques described herein may be used to bridge the gap between authoring a presentation and delivering the presentation by enabling a presentation authoring application to provide practice sessions, such as timed rehearsals, to improve delivery. For example, a presentation authoring application may include features to enable a user (e.g., a presenter) to perform extended authoring and targeted rehearsal. Extended authoring refers to enabling a presenter to specify how the presenter intends to (i) verbally expand on of each element (e.g., words and/or images) in a slide in a presentation, (ii) speak to visual elements in a particular order, and (iii) speak for a particular time for each slide and for the overall presentation. Targeted rehearsal may encompass several different rehearsal modes in which the presenter is trained to (i) recall how to verbally expand on each visual element, (ii) recall the content of slides and the verbal path through multiple slides, and (iii) speak for a target time for each slide, including accounting for trial and error.

Extended authoring and targeted rehearsal may provide a structured approach that guides presenters through the process of creating and rehearsing delivery of presentations. For example, the structured approach may cause the presenter to think about how to add value to visuals (e.g., slides) with speech, think about how to provide a presentation flow that makes sense to listeners, practice by speaking aloud, practice repeatedly, create element notes that detail what to say about each visual element, create flow paths that detail how to transition between visual elements and between slides, and create time targets that detail a length of time to speak to each slide and to each of the visual elements.

### ILLUSTRATIVE ARCHITECTURES

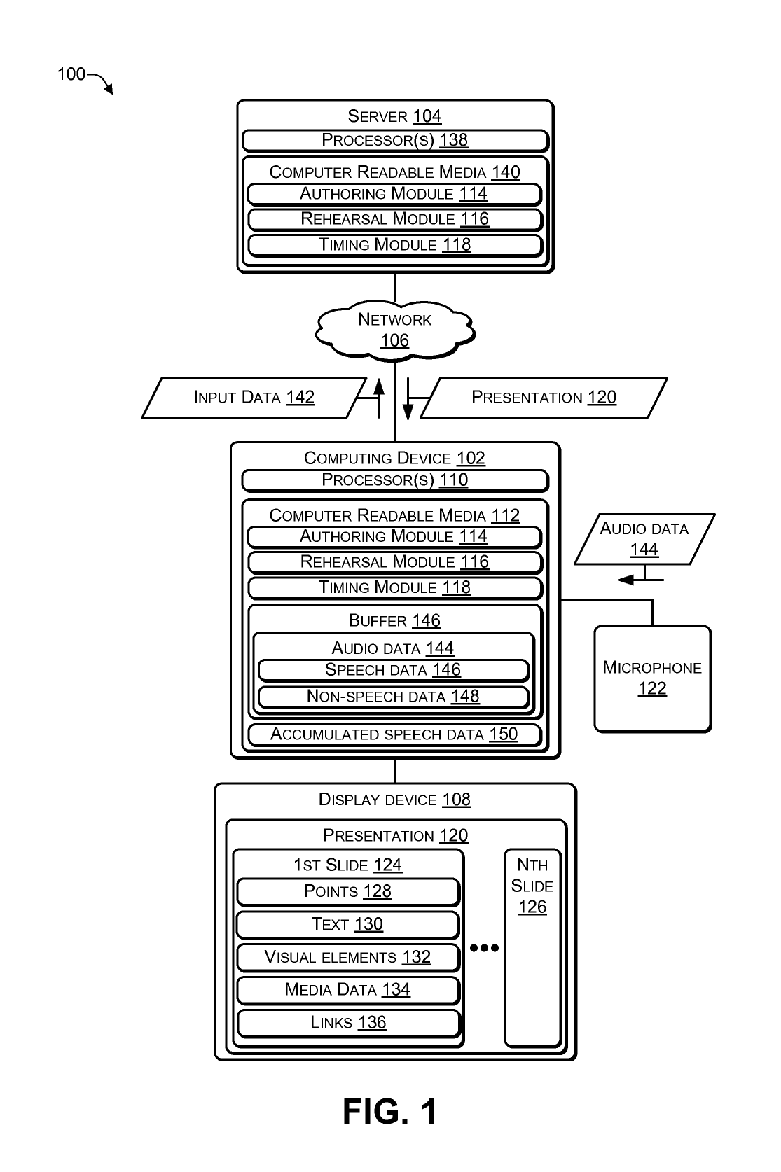

FIG. 1 is an illustrative architecture 100 to create and rehearse a presentation according to some implementations. The architecture 100 includes a computing device 102 coupled to a server 104 via a network 106. The network 106 may include one or more networks, such as a wireless local area network (e.g., WiFi®, Bluetooth™, or other type of near-field communication (NFC) network), a wireless wide area network (e.g., a code division multiple access (CDMA), a global system for mobile (GSM) network, or a long term evolution (LTE) network), a wired network (e.g., Ethernet, data over cable service interface specification (DOCSIS), Fiber Optic System (FiOS), Digital Subscriber Line (DSL) and the like), other type of network, or any combination thereof.

The computing device 102 may be coupled to the display device 108, such as a monitor. In some implementations, the display device 108 may include a touchscreen. The computing device 102 may be a desktop computing device, a laptop computing device, a tablet computing device, a wireless phone, a media playback device, a media recorder, another type of computing device, or any combination thereof. The computing device 102 may include one or more processors 110 and one or more computer readable media 112. The computer readable media 112 may include instructions that are organized into modules and that are executable by the one or more processors 110 to perform various functions. For example, the computer readable media 112 may include modules of a presentation authoring application, such as an authoring module 114, a rehearsal module 116, and a timing module 118. The authoring module 114 may enable a user of the computing device 102 to author a presentation 120, including specifying talking points to be made about visual elements of the presentation, the relationships between the talking points, and the like.

The rehearsal module 116 may enable the user to rehearse delivery of the presentation 120 after authoring the presentation 120. The timing module 118 may enable the user to time the rehearsals of delivery of the presentation 120. In some cases, the computing device 102 may be coupled to a microphone 122. During rehearsals, the timing module 118 may record the delivery of the presentation 120, analyze the recorded delivery, and provide the user with detailed timing information regarding delivery of the presentation 120. For example, the detailed timing information may include an overall length of the presentation 120 as measured by audio (e.g., speech) associated with delivery of the presentation 120, a length of each slide within the presentation 120 as measured using audio associated with delivery of each slide, a length of each visual element within each slide as measured using audio associated with delivery of each visual element, etc.

The presentation 120 may include one or more slides, such as a first slide 124 to an Nth slide 126 (where N>1). Each of the N slides may include one or more points 128, text 130, one or more visual elements 132, media data 134, links 136, or any combination thereof. Of course, other types of data may also be included in the presentation 120. The points 128 may include one or more primary concepts or ideas that are to be conveyed to the audience. The points 128 may be conveyed using one or more of the text 130, the visual elements 132, or the media data 134. The text 130 may include text that specifies details associated with one or more of the points 128. The one or more visual elements 132 may include images (e.g., photographs, graphics, icons, or the like) that visually illustrate one or more of the points 128. The media data 134 may include audio data, video data, or other types of media data that may be played back to illustrate one or more of the points 128. The links 136 may be specified by a user and may be used to connect different points (e.g., from the points 128) and different slides (e.g., from the N slides 122 to 124) with each other to enable a presenter to dynamically provide additional details associated with a particular point during the presentation. For example, based on the type of audience to which the presentation is being given, different questions may arise relating to the same point. The links 136 may enable the presenter to branch off and present additional information to answer different questions arising from the same point. Thus, the links 136 may enable the presenter to dynamically customize the delivery of the presentation 120 while presenting the presentation 120.

The server 104 may include one or more processors 138 and one or more computer readable media 140. The computer readable media 140 may include one or more of the authoring module 114, the rehearsal module 116, or the timing module 118. In some cases, one or more of the modules 114, 116 or 118 may be downloaded from the server 104 and stored in the computer readable media 112 to enable a user of the computing device 102 to use the modules 114, 116 or 118. In other cases (e.g., in a cloud computing environment), the server 104 may host one or more of the modules 114, 116 or 118 and the computing device 102 may access one or more of the modules 114, 116 or 118 using the network 106. For example, the computing device 102 may send input data 142 to the server 104. The input data 142 may include authoring information, such as points to be made in a presentation, the relationship between the points, and specified styles. The server 104 may generate the presentation 120 based on the input data 142 and send the presentation 120 to the computing device 102. In some implementations, the modules 114, 116, or 118 may be distributed across multiple computing devices, such as the computing device 102 and the server 104.

During rehearsal (e.g., also referred to herein as targeted rehearsal) the user may rehearse delivering various portions of the presentation 120 to satisfy predetermined time targets for each of the visual elements 132, each of the slides 124 to 126, and/or the presentation 120 as a whole. During the rehearsal, the timing module 118 may use automatic speech detection to determine times during which the user is speaking. For example, the timing module 118 may continuously monitor audio data 144 received from the microphone 122. The audio data 144 may be associated with the user speaking to a visual element or a slide of the presentation 120. For example, a first visual element in a slide may result in first audio data being recorded, a second visual element in the slide may result in second audio data being recorded, and so on. As another example, a first slide may result in first audio data being recorded, a second slide may result in second audio data being recorded, and so on.

The audio data 144 received from the microphone 122 may be stored in a buffer 146 of the computing device 102. The timing module 118 may identify a speech data 148 portion of the audio data 144 and a non-speech data 150 portion of the audio data 144. For example, the speech data 148 portion may include various times intervals during the rehearsal in which the user is speaking. The non-speech data 150 portion may include various time intervals during the rehearsal in which the user is not speaking. The timing module 118 may discard the non-speech data 150 portion of the audio data 144. The timing module 118 may save the speech data 148 portion of the audio data 144 in accumulated speech data 152. The accumulated speech data 152 may thus include multiple portions of saved speech that are accumulated during the rehearsal. Each portion of saved speech in the accumulated speech data 152 may include a first pre-determined amount of time (e.g., half a second, one second, etc.) before the user begins speaking and a second pre-determined amount of time after the user has stopped speaking.

During rehearsal, while the user is speaking, the rehearsal module 116 may display a visual indicator on the display device 108 indicating that the speech is being recorded. The timing module 118 may determine timing information based on the speech data 148 and the accumulated speech data 152. The timing module 118 may display information identifying various timing-related information, such as a duration (e.g., time interval) of the current speech, a cumulative total for a visual element in a slide, a cumulative total for a current slide, a cumulative total for the presentation 120, other timing-related information, or any combination thereof. The timing module 118 may continuously update the timing-related information that is displayed relative to time targets set by the user. For example, the time targets may include time targets to present (e.g., deliver) (1) each of the visual elements 132, (2) each of the slides 124 and 126, and/or (3) the presentation 120.

During rehearsal, the user may choose to keep the speech data 148 and have the speech data 148 added to the accumulated speech data 152 or discard the speech data 148 and provide additional audio data (e.g., by speaking again) from which to derive additional speech data for inclusion in the accumulated speech data 152. For example, by default, the timing module 118 may add a most recent speech data 148 to the accumulated speech data 152. The user may override the default setting and discard the speech data 148 to enable the user to repeat delivery of a portion of the presentation 120. The user may also use manual recording controls to manually record and save the speech data 148 in the accumulated speech data 152. Thus, the accumulated speech data 152 may include speech data associated with multiple visual elements and/or multiple slides. For example, the accumulated speech data 152 may include first speech data associated with a first visual element (or a first slide), second speech data associated with a second visual element (or a second slide), and so on. To illustrate, during early rehearsals, for at least some visual elements, the user may record the user's speech when speaking to each visual element. In later rehearsals (e.g., when the user can recall the visual elements in each slide), for at least some of the slides, the user may record the user's speech when speaking to each slide.

A user may utilize timed speech rehearsal to enable the user to think about what to say and take as long as the user desires to discuss each visual element and slide without having pauses or breaks in the delivery counted against the time targets. Timed speech rehearsal may provide an opportunity for the user to repeatedly rehearse different portions of the presentation 120 and have user-selected portions of the rehearsal used to determine various timing information. The accumulated speech data 152 may be viewed as an “ideal delivery,” e.g., a delivery that is close to ideal in terms of content and circumstances. The content may be ideal to the extent that the user can rehearse and select the speech data 148 that is included in the accumulated speech data 152. The circumstances may be ideal to the extent that time guides and speaker notes may be displayed and because an audience is not present.

Thus, the computing device 102 may enable a user to author and rehearse a presentation 120. In some cases, the presentation 120 may be generated by the computing device 102 and stored in the computer readable media 112. In other cases, the server 104 may generate the presentation 120 and store the presentation 120 in the computer readable media 140 based on the input data 140 provided by the computing device 102. The presentation 120 may be presented on the display device 108 using the computing device 102, the server 104, or another computing device. For example, the presentation 120 may be authored and generated using the computing device 102 and/or server 104 but may be presented using a different computing device.

The computing device 102 and/or the server 104 may enable the user to perform extended authoring and timed rehearsal of the presentation 120. The timed rehearsals may aid the user in recalling visual elements and notes associated with each visual element as well as delivering the presentation 120 within a predetermined period of time.

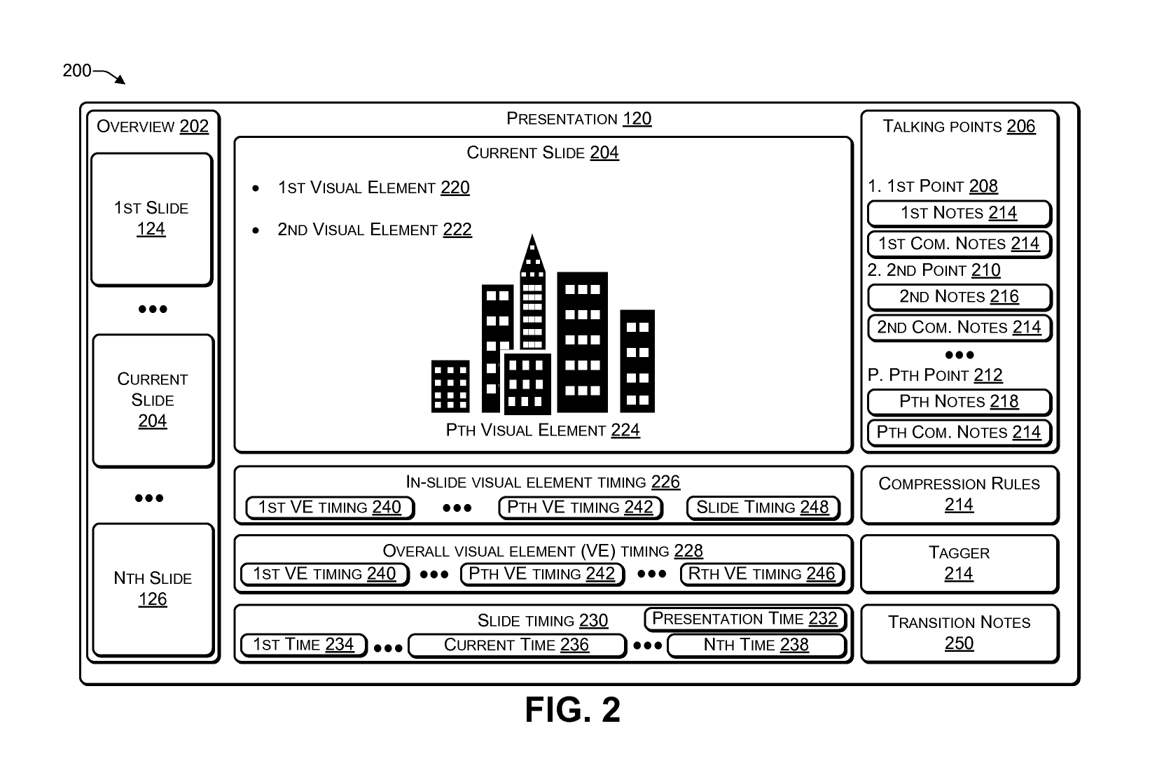

FIG. 2 is an illustrative architecture 200 to display and rehearse a presentation according to some implementations. The architecture 200 illustrates how a module of presentation authoring application (e.g., the rehearsal module 116 of FIG. 1) may enable a user to display, rehearse, and time a presentation (e.g., the presentation 120).

Various graphical user elements are illustrated in the architecture 200. However, in a given implementation, not all of the graphical user elements that are illustrated may be displayed. For example, some implementations may offer a subset of the illustrated graphical user elements or the presentation authoring application may enable the user to select which subset of the illustrated graphical user elements are displayed.

In FIG. 2, an overview pane 202 may be displayed and may include at least some of the individual slides (e.g., at least some of the slides 124 to 126) that are part of the presentation 120 to enable the user to visually view a context of a current slide 204. The current slide 204 (e.g., one of the slides 124 to 126) may be displayed to prompt the user to begin discussing various talking points 206. For example, the current slide 204 may have P talking points (P>0), such as a first point 208, a second point 210, up to a Pth point 212. At least one of the P talking points 208, 210, or 212 may have associated speaker notes. A talking point may be a brief description, typically no more than a few words, identifying a topic to be discussed. The notes corresponding to a talking point may elaborate on the talking point include one or more sentences that describe the talking point in more detail. The talking point may be designed to cue the user to recall the corresponding notes. As illustrated in FIG. 2, the first point 208 may have first notes 214, the second point 210 may have second notes 216, and the Pth point 212 may have Pth notes 218. When creating the presentation 120, the user may add one or more of the notes 214, 216, or 218. In some cases, automated speech recognition technology may be used to automatically transcribe speech data 148 to create one or more of the notes 214, 216, or 218.

Each of the talking points 206 may correspond to a visual element (e.g., text, a graphical image, or a media clip) in the current slide 204. For example, a first visual element 220 may correspond to the first point 208, a second visual element 222 may correspond to the second point 210, and a Pth visual element 224 may correspond to the Pth point 212. In FIG. 2, each visual element in the current slide 204 is illustrated as having a corresponding talking point and set of notes. However, in some cases, not every visual element in a given slide may have a corresponding point or set of notes, e.g., two or more visual elements may be associated with the same talking point. For example, a first visual element (e.g., text) may use a second visual element (e.g., a graphical image) to visually illustrate the point being made by the first visual element. In this example, both the first visual element (e.g., text) and the second visual element (e.g., the graphical image) may be associated with the same talking point. To illustrate, the text in a first visual element may describe a percentage while the second visual element may use a pie-chart, bar graph or other graphic to visually illustrate the percentage mentioned in the first visual element.

During rehearsal or delivery of the presentation 120, to aid the presenter in remembering the talking points 206, one or more of the visual elements 220, 222 or 224 may be displayed. If the user does not recall the talking point corresponding to a visual element that is being displayed, the corresponding talking point (e.g., one of the talking points 206) may be displayed automatically (e.g., after a predetermined period of time has elapsed or in response to user input). If the user does not recall the notes associated with the talking point, the notes corresponding to the talking point may be displayed (e.g., after a predetermined period of time has elapsed or in response to user input). For example, the first visual element 220 may be displayed. If the user does not recall the talking point corresponding to the first visual element 220 that is being displayed, the corresponding first point 208 may be displayed after a predetermined period of time has elapsed or in response to user input. If the user does not recall the notes associated with the first point 208, the first notes 214 corresponding to the first point 208 may be displayed after a predetermined period of time has elapsed or in response to user input. This process may be repeated for additional visual elements, such as the second visual element 222 with the corresponding second point 210 and the corresponding second notes 216 and/or the Pth visual element 224 with the corresponding Pth point 212 and the corresponding Pth notes 218.

When the user is rehearsing, to recall the talking point and notes associated with each visual element of a slide, the user may provide navigation input to navigate portions of the presentation 120, e.g., input to advance to a specified portion of the current slide 204. For example, the navigation input may display one or more of the points 208, 210, or 212 corresponding to the visual elements 220, 222, or 224. The user may provide additional navigation input to display one or more of the notes 214, 216, or 218 corresponding to the visual elements 220, 222, or 224. Alternately, or in addition to the user provided navigation input, the presentation authoring application may automatically display the points 208, 210, or 212 and/or the notes 214, 216, or 218. For example, the user may enter timing information or the presentation authoring application may determine timing information (e.g., by monitoring audio input received from a microphone), and the presentation authoring application may automatically display one or more of the points 208, 210, or 212 and the notes 214, 216, or 218 based on the timing information. The user may also provide navigation input to move from displaying the current slide 204 to displaying a next slide or a previous slide.

In some cases, the presentation authoring application may monitor the user's delivery of the presentation 120 using the audio input received via the microphone 122 and automatically (e.g., without human interaction) display one or more of the points 208, 210, or 212 and the notes 214, 216, or 218 in response to detecting a pause (e.g., silence) greater than a threshold time. For example, in response to viewing the Pth visual element 224, the user may not recall the Pth point 212 or the Pth notes 218, resulting in the user pausing when speaking. The presentation authoring application may detect the pause (e.g., using the microphone 122) and automatically display the Pth point 212 or the Pth notes 218. For example, if the Pth point 212 has not been displayed, the presentation authoring application may, in response to detecting a pause, automatically display the Pth point 212. If the Pth notes 218 have not been displayed, the presentation authoring application may, in response to detecting a pause, automatically display the Pth notes 218. In addition, the user may manually display the Pth point 212 or the Pth notes 218 without waiting for the presentation authoring application to detect a pause in the user's speech.

During rehearsal and/or delivery, the presentation authoring application may display various timing-related information, such as how much time the user has spent talking about each of the visual elements 220, 222, or 224, each of the slides 124 to 126, the time for the presentation 120 up to the current slide 204, and the total (e.g., projected or estimated) time to deliver the presentation 120. For example, the timing-related information may include in-slide visual element timing 226, overall visual element timing 228, and/or slide timing 230. Of course, the presentation authoring application may enable the user to select other timing-related information to be displayed in addition to (or instead of) the timings 226, 228, or 230. As another example, the presentation authoring application may provide a comparison of a target time (e.g., set by the user when authoring the presentation) to an actual time (e.g., as measured by monitoring the speech data 148) for each visual element, each slide, and/or the presentation as a whole. The timing-related information may be useful for both individual portions of the presentation (visual element, series of visual elements, one or more talking points, one or more slides, etc.) and also for tracking progress through the entire presentation against the target time. The timing-related information may enable the presenter to prioritize and modify which visual elements and/or slides are presented as the presentation progresses to mindfully achieve the overall time target.

The slide timing 230 may display a presentation time 232 that displays an estimated amount of time to deliver (e.g., present) the presentation 120. The presentation time 232 may be based on user input, automatically determined by the presentation authoring application after the user has rehearsed delivery of the presentation 120, or a combination of both. For example, the user may input the presentation time 232 when the user has been allotted a predetermined amount of time to deliver the presentation 120. As another example, during rehearsal, the presentation authoring application may monitor the delivery of the presentation 120 using the microphone 122. The presentation authoring application may determine the presentation time 232 based on monitoring the rehearsal delivery of the presentation 120. The timing-related information illustrated in FIG. 2 may include projected times, estimated times, approximate times, or a combination thereof and may be determined based on time input by the user, timing information derived from monitoring the rehearsed delivery of the presentation 120, or a combination of both.

The slide timing 230 may display an amount of time associated with each slide of the presentation 120. For example, a first time 234 may identify a time to deliver (e.g., present) the first slide 124, a current time 236 may identify a time to deliver the current slide 204, and an Nth time may identify a time to deliver the Nth slide 126. The times 234, 236, and 238 may be displayed as numeric values (e.g., 1 minute, 2 minutes, 5 minutes, etc.), as graphical values (e.g., a size of each graphic that represents the times 234, 236, and 238 may be proportional to the delivery time of the corresponding slides 124, 204, and 126, respectively), or a combination of both.

The overall visual element (VE) timing 228 may identify a total number of visual elements in the presentation 120 and an amount of time to deliver each visual element. For example, for the current slide 204, the first VE timing 240 may identify an amount of time to deliver the first visual element 220 and the Pth VE timing 242 may identify an amount of time to deliver the Pth visual element 224. An Rth VE timing 246 (R>0) may identify an amount of time to deliver a visual element of the N slides 124 to 126. For example, the Rth VE timing 246 may identify an amount of time to deliver a last visual element of the Nth slide 126 of the presentation 120. The VE timing 240, 242, and 246 may be displayed as numeric values (e.g., 1:00 minute, 2:45 minutes, 5:30 minutes, etc.), as graphical values (e.g., a size of each graphic that represents the times 240, 242, and 246 may be proportional to the delivery time of the corresponding visual element), or a combination of both.

The in-slide visual element timing 226 may include slide timing 248 that identifies an estimate to deliver (e.g., present) the current slide 204. Thus, the slide timing 248 may identify the time to deliver each of the visual elements 220, 222, and 224 of the current slide 204. For example, the first VE timing 240 may identify an estimated time to deliver the first visual element 220 and the Pth VE timing 242 may identify an estimated time to deliver the Pth visual element 224. In situations where visual element time targets (e.g., VE timing 240, 242, and 246) have not been specified, or when the user desires to override the visual element time targets, the user may provide navigation input to manually move forward or back between visual elements or between slides. The navigation input may be provided using various input mechanisms, such as cursor keys, designated keys of a conventional QWERTY-based keyboard, swipe gestures, a mouse, voice recognition, another type of input mechanism, or any combination thereof.

During rehearsal and/or delivery of a presentation, the presentation authoring application may display transition notes 250. The transition notes 250 may include information associated with transitioning from the current slide 204 to a next slide of the presentation 120.

In some situations, such as when there are relatively few visual elements on the current slide 204, and the presenter is speaking to the current slide 204 for a relatively long period of time, note compression may be used during rehearsal. Note compression may include reducing (e.g., compressing) text in one or more of the notes corresponding to the visual elements in a slide, to create compressed notes. For example, the notes 214, 216, or 218 may be compressed to create compressed notes (denoted as “com. notes” in FIGS. 2) 252, 254, and 256, respectively, according to a set of compression rules 258. The compression rules 258 may be created by the presentation authoring application based on contents of the slide (e.g., the current slide 204) in which the notes are located, word and phrase frequencies of the notes, and/or sentence structures. For example, when a notes section is compressed, words may be removed, replaced, and/or abbreviated from the notes based on a part of speech associated with each word. For example, a part of speech tagger 260 may tag each word in notes (e.g., the notes 214, 216, and 218) according to the part of speech associated with each word. Parts of speech may be removed from notes based on an order that reflects the ease with which a presenter may recall the content of the notes after rehearsing the notes at an original (non-compressed) or prior compression level. For example, the first rehearsal may be performed using uncompressed notes, the second rehearsal may be performed using compressed notes in which a first group (e.g., a first type from the parts of speech) has been removed, the third rehearsal may be performed using compressed notes in which the first group and a second group (e.g., a second type from the parts of speech) has been removed, and so on. The words that remain in the compressed notes may be biased against any words or phrases that are repeated within the same slide or throughout the presentation, in favor of words or phrases that are relatively uncommon. For example, words and/or phrases that are common (e.g., articles such as “a,” “an,” “the,” etc.) to a slide or the presentation may be removed before words that are relatively uncommon to the slide or the presentation. The purpose of note compression is to enable the user to, with each successive rehearsal, rely less and less on the content of the notes.

Other techniques may be used in addition to or in instead of using the tagger 260 to tag parts of speech and using the compression rules 258 to compress one or more of the notes 214, 216, or 218. For example, a user may manually select portions of the notes 214, 216, or 218 for compression. As another example, one or more of the notes 214, 216, or 218 may be compressed using dependency tree based sentence compression, in which a grammatical structure of each sentence may be used to determine details (e.g., words or phrases) that can be compressed. As yet another example, supervised machine learning (e.g., using a training set that includes a corpus of sentences and corresponding compressed equivalents) may be used to compress one or more of the notes 214, 216, or 218.

During extended authoring and targeted rehearsal, the presentation authoring application may track the user's progress and display information (e.g., metrics) to motivate the user to continue with the extended authoring and/or targeted rehearsal. Example metrics that may be displayed include a percentage of visual elements with completed notes, a percentage of visuals with time targets, a number of iterations of each type of rehearsal, a number of correctly and incorrectly anticipated visual elements or notes (e.g., by capturing audio, converting the audio to text, and comparing the converted text with the notes) and the distribution across the slides of the presentation, a total time spent speaking, a ratio of speaking time to non-speaking time during timed speech rehearsal, other authoring-related or rehearsal-related information, or any combination thereof. Displaying various metrics may provide the user information to self-evaluate the user's readiness to deliver the presentation.

During delivery and/or rehearsal, the computing device 102 may automatically (e.g., without human interaction) advance to a next slide or a next visual element based on comparing the speech data 148 with one or more of the notes 214, 216, or 218. For example, the computing device 102 may use automated speech recognition to convert the speech data 148 to recognized text and compare the recognized text with one or more of the notes 214, 216, or 218. If the recognized text differs from one or more of the notes 214, 216, or 218 by less than a predetermined threshold, the computing device 102 may (1) advance from highlighting a current visual element (of the visual elements 220, 222, or 224) to highlighting a next visual element, (2) advance from identifying a position of a current visual element to identifying a position of a next visual element, or (3) advance from the current slide 204 to a next slide. For example, the computing device 102 may automatically advance based on whether the recognized text differs from one or more of the notes 214, 216, or 218 by less than a predetermined number of words, by less than a predetermined percentage of words, or the like. To illustrate, the computing device 102 may use automated speech recognition to convert the speech data 148 to recognized text and compare the recognized text with one or more of the notes 214, 216, or 218. In some cases, the comparison may be a numeric comparison, such as comparing the number of words in the recognized text with the number of words in one or more of the notes 214, 216, or 218. Alternately or additionally, a percentage may be determined based on the number of word matches divided by the total number of words in the recognized text (or the total number of words in the notes 214, 216, or 218). In other cases, the comparison may be a word comparison that identifies which of the words in the recognized text are included in the notes 214, 216, or 218. The computing device 102 may use speech synthesis technology to speak out the words in the notes 214, 216, or 218 that were not included in the recognized text (excluding certain parts of speech). For example, “When speaking the first set of notes on slide two, the following words were not identified: turbulence, monetary and compensation.” Such automated advancement may encourage presenters to practice speaking aloud.

During rehearsal of the presentation 120, text to speech technology may be used to provide synthesized speech for the talking points 206 and/or the notes 214, 216, or 218. The user may listen to the synthesized speech for a hands-free and/or eyes-free review of the presentation 120 or to review the flow of the presentation 120. Text to speech technology may be used to assist the user in recalling the notes 214, 216, or 218. For example, after a user has spoken a particular set of notes of the notes 214, 216, or 218 aloud, synthesized speech may be output for the particular set of notes to enable the user to determine how much of the particular set of notes the user was able to recall. As another example, synthesized speech may be output for a particular set of notes before the user has spoken to assist the user in recalling the particular set of notes. In some cases, the computing device 102 may advance a portion (e.g., visual element or slide) of the presentation 120 based on the speech data 148 associated with speaking the particular set of notes aloud.

Thus, a presentation authoring application may provide various types of information during rehearsal and/or delivery of a presentation. The information that is displayed may be used to assist the user in (1) recalling talking points and notes associated with visual elements (e.g., text, graphical images, media, etc.) in each slide and (2) keeping the user on-track with respect to a timing of each visual element, each slide, and the presentation as a whole.

### Example Processes

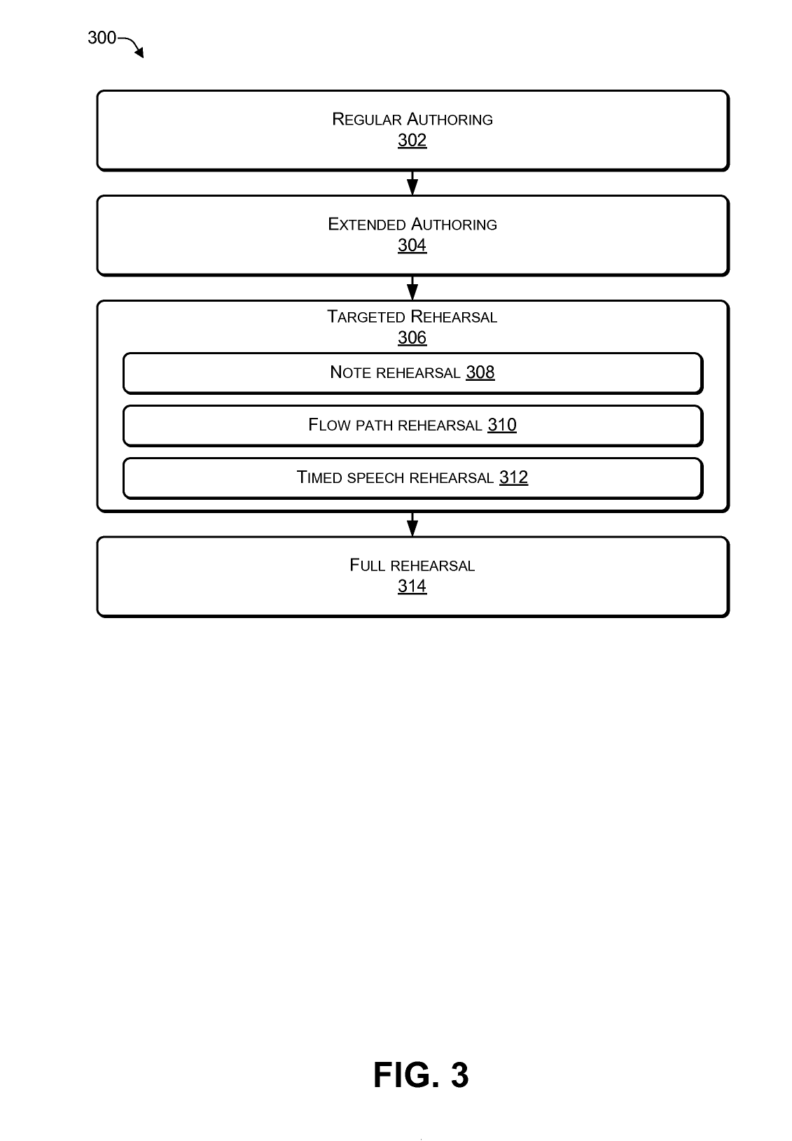

In the flow diagrams of FIGS. 3-8, each block represents one or more operations that can be implemented in hardware, software, or a combination thereof. In the context of software, the blocks represent computer-executable instructions that, when executed by one or more processors, cause the processors to perform the recited operations. Generally, computer-executable instructions include routines, programs, objects, modules, components, data structures, and the like that perform particular functions or implement particular abstract data types. The order in which the blocks are described is not intended to be construed as a limitation, and any number of the described operations can be combined in any order and/or in parallel to implement the processes. For discussion purposes, the processes 300, 400, 500, 600, 700 and 800 are described with reference to the architectures 100 and 200 as described above, although other models, frameworks, systems and environments may be used to implement these processes.

FIG. 3 is a flow diagram of an example process 300 that includes targeted rehearsal according to some implementations. The process 300 describes how a user may use a presentation authoring application (e.g., the modules 114, 116, and 118 of FIG. 1) to author and rehearse delivery of a presentation.

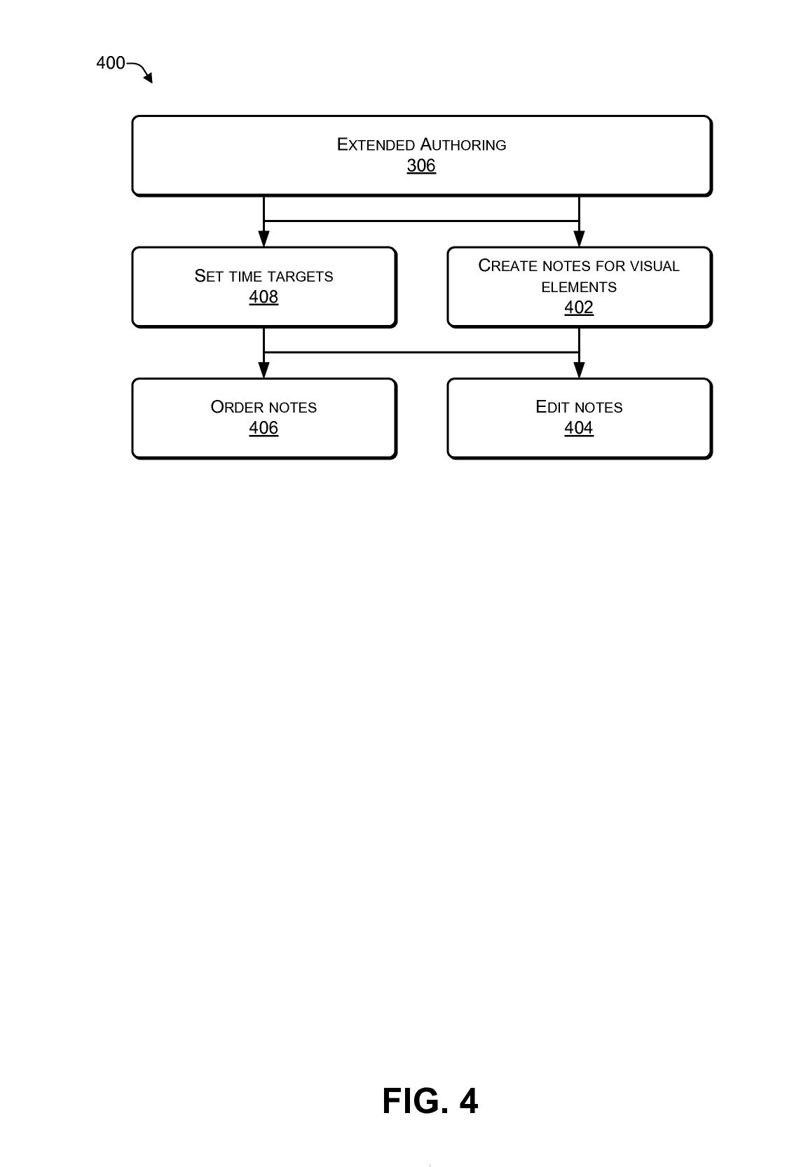

At 302, the user may author a presentation. For example, in FIG. 1, a user may use the authoring module 114 to author a presentation, such as a set of one or more PowerPoint® slides. The authoring at 302 may be regular authoring rather than extended authoring, which is described in more detail in FIG. 4.

At 304, the user may perform extended authoring. For example, in FIG. 1, a user may use the authoring module 114 to enter an extended authoring mode. Extended authoring may enable a user to add notes for visual elements in each slide and is described in more detail in FIG. 4. The authoring module 114 may enable the user to switch back and forth between regular authoring and extended authoring as the user desires.

At 306, targeted rehearsal may be performed. For example, the user may enter a rehearsal mode of a presentation authoring application and rehearse delivering the presentation to previously determined time targets. The targeted rehearsal may include one or more of note rehearsal 308, flow path rehearsal 310, and timed speech rehearsal 312. In the note rehearsal 308, the user may rehearse recalling the notes corresponding to visual elements of a presentation. In the flow path rehearsal 310, visual elements may be hidden and later revealed to assist the user in determining whether the flow of the visual elements makes sense and to train the user to recall what visual element (and the corresponding talking point and notes) comes next. For example, a visual element may be hidden to provide the user an opportunity to recall the visual element and the corresponding talking point. After a predetermined period of time or in response to user input, the visual element may be revealed to enable the user to determine whether the user was able to recall the visual element and the corresponding talking point. In the timed speech rehearsal 312, time targets set during extended authoring may guide the delivery of each visual element, the corresponding talking point, and the corresponding notes.

At 314, a full rehearsal may be performed. For example, the user may enter a rehearsal mode to enable the user to rehearse delivering the presentation, including discussing each talking point and associated notes. The user may use timing-related information, such as the timing-related information described in FIG. 2, to enable the user to deliver the presentation approximately within a predetermined period of time.

Thus, a presentation authoring application may enable a user to author a presentation and then perform extended authoring, in which the user adds notes corresponding to visual elements of slides of the presentation. The presentation authoring application may enable the user to perform different types of rehearsals to enable the user to recall the visual elements and corresponding talking points and notes, recall transitions from one slide to another, and time the rehearsals to enable the user to deliver the presentation approximately within a predetermined amount of time.

FIG. 4 is a flow diagram of an example process 400 that includes extended authoring according to some implementations. The process 400 describes how a user may use a presentation authoring application (e.g., the modules 114, 116, and 118 of FIG. 1) to perform extended authoring of a presentation. The extended authoring 304 may help prepare a user to deliver a presentation while reducing psychological pressures associated with public speaking. The user may perform one or more of the activities of extended authoring, such as 402, 404, 406, and 408, in parallel (e.g., substantially contemporaneously).

At 402, notes for visual elements may be created. For example, in an extended authoring mode, the authoring module 114 may enable the user to instruct the authoring application to automatically create note placeholders corresponding to the visual elements of each slide, or manually create note placeholders corresponding to specific visual elements of each slide. To illustrate, in FIG. 2, the authoring module 114 may enable the user to automatically or manually create note placeholders for one or more of the notes 214, 216, and 218. The note placeholders may enable the user to store and edit notes identifying how the user intends to discuss and/or expand on the corresponding talking points and visual elements. The note placeholders may be added in several ways, e.g., displayed in a side panel as in FIG. 2, created in response to a command (e.g., a touch gesture on a touch-sensitive display, a key press of a keyboard, a speech command, and the like).

At 404, the notes may be edited. For example, the note placeholders may be edited using keyboard input, handwriting recognition, speech recognition, created directly as ink or voice annotations, and/or by scanning documents.

At 406, the notes may be ordered (or reordered). For example, the notes may be ordered to reflect a speaking order, e.g., the order in which the user intends to present (e.g., speak to) the visual elements corresponding to the notes. The notes may be ordered (or reordered) in several different ways, such as representing the notes in a slide as a list of objects that can be directly reordered by the user or a visual flow path may be overlaid on the slide and the order of the nodes (e.g., where each node represents a visual element) in the flow path may be changed. Transition notes, such as the transition notes 250 of FIG. 2, may be created to detail how to transition from each slide to a next slide to enable one slide to smoothly transition to the next slide.

At 408, the user may set a time target for one or more of the presentation, each slide in the presentation, and each visual element (e.g., talking point). In addition to helping the user stay or get back on track during presentation delivery, the time targets may guide the user during rehearsal in regards to the number of notes and the length of the notes that can be presented in a particular period of time.

Thus, during extended authoring, a user may create notes for visual elements, edit the notes, order (and reorder) the notes, and set time targets for the presentation, slides of the presentation, and/or visual elements of the slides. The notes may be displayed in an order that corresponds to the order of the visual elements in a slide or in a different order (e.g., an order that is unrelated to the order of the visual elements). The notes may be displayed on a specified display device. For example, during presentation, the notes may be displayed on a display device that is only visible to the presenter but not visible to the audience. Where the notes each correspond to a visual element, the order of the notes may be according to a flow path specified by the user. Two or more of the activities performed in extended authoring may be performed substantially at the same time (e.g., in parallel).

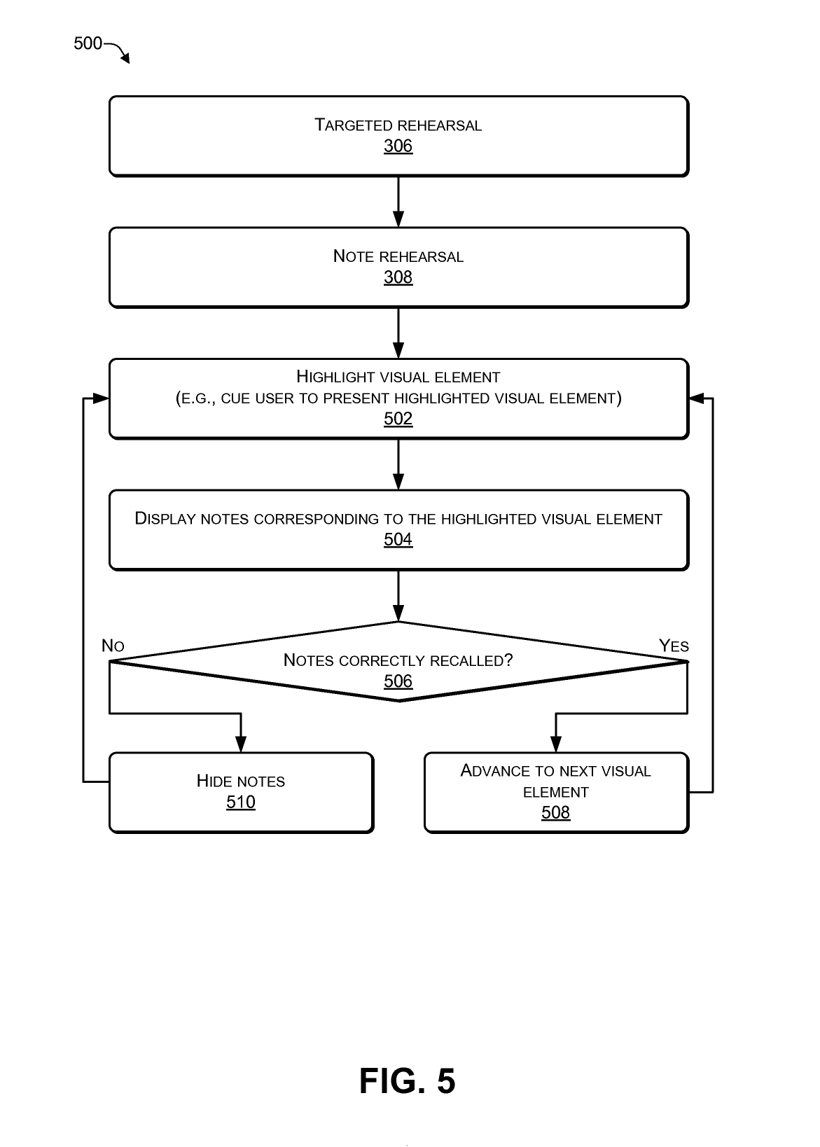

FIG. 5 is a flow diagram of an example process 500 that includes note rehearsal according to some implementations. The process 500 describes how a user may use a presentation authoring application (e.g., the modules 114, 116, and 118 of FIG. 1) to rehearse delivering one or more notes from a presentation.

At 306, the user may enter a targeted rehearsal mode. The targeted rehearsal mode may enable the user to perform various types of rehearsals. At 308, the user may rehearse delivering one or more notes (e.g., the notes 214, 216, and 218 of FIG. 2). During note rehearsal, the user may train themselves to recall the contents of the notes for each visual element.

During note rehearsal, at 502, a visual element may be highlighted. For example, in FIG. 2, one of the visual elements 220, 222, or 224 may be highlighted to cue the user to recall and present (e.g., speak) the notes corresponding to the highlighted visual element. Highlighting a visual element refers to visually modifying the visual element to stand out from the other visual elements and may include one or more of changing a background color of the visual element, changing a foreground color of the visual element, changing a font of text in the visual element, changing a font characteristic (e.g., bold, underline, italics, or the like) of text in the visual element, etc.

At 504, notes corresponding to the highlighted visual element may be displayed. For example, the notes corresponding to the highlighted visual element may be displayed (1) automatically after a predetermined amount of time has passed (e.g., an amount of time entered by the user or estimated by the authoring application), (2) in response to the authoring application detecting a pause (e.g., by monitoring the microphone 122) during rehearsal, or (3) in response to user input indicating that the user has completed speaking to the highlighted visual element. The notes associated with the highlighted visual element may be displayed to enable the user to determine if the user correctly recalled the notes.

At 506, a determination may be made whether the user was able to correctly recall the notes. If the user was able to recall the notes based on the highlighted visual element, then the highlighted visual element successfully cued (e.g., triggered) recall of the notes. Repeatedly rehearsing using cued recall until the user can reliably recall the notes of visual elements may improve the user's ability to remember what to say during delivery of the presentation to an audience.

If the user correctly recalled the notes associated with the highlighted visual element, at 506, then the presentation may advance to a next visual element, at 508, and the process may repeat starting at 502, where the next visual element may be highlighted.

If the user was unable to correctly recall the notes (e.g., partial or no recall) associated with the highlighted visual element, the user may perform more practice of cued-recall. At 510, the notes that were displayed in 504 may be hidden and the process may be repeated by highlighting the visual element, at 502.

The rehearsal mode may enable the user to move forward and backward through a predetermined sequence of element highlights and note reveals as if the user was navigating through a regular slide presentation. In such cases, the user may select what to do upon failing to correctly recall the notes of the highlighted visual element, e.g., go back (e.g., to 502) and try again, or continue to the end of the presentation and go through the presentation again. The rehearsal mode may track when the user correctly recalls visual elements or notes and when the user incorrectly recalls visual elements or notes to dynamically train recall of notes in accordance with principles of spaced repetition learning.

Thus, during note rehearsal, visual elements of a presentation may be highlighted in turn (e.g., in the order of the flow path) to cue the user to recall the corresponding notes. If a highlighted visual element does not cause the user to correctly recall the corresponding notes, the user may (1) hide the notes and practice recalling the notes associated with the highlighted visual element, (2) proceed with recalling any remaining notes of a current slide and then repeat rehearsal of recalling the notes using the visual elements of the current slide, or (3) proceed with recalling any remaining notes of the presentation and then repeat rehearsal of recalling the notes of the presentation. In this way, note rehearsal may result in the visual elements cueing the user's recall of the associated notes to enable the user to provide a smooth presentation.

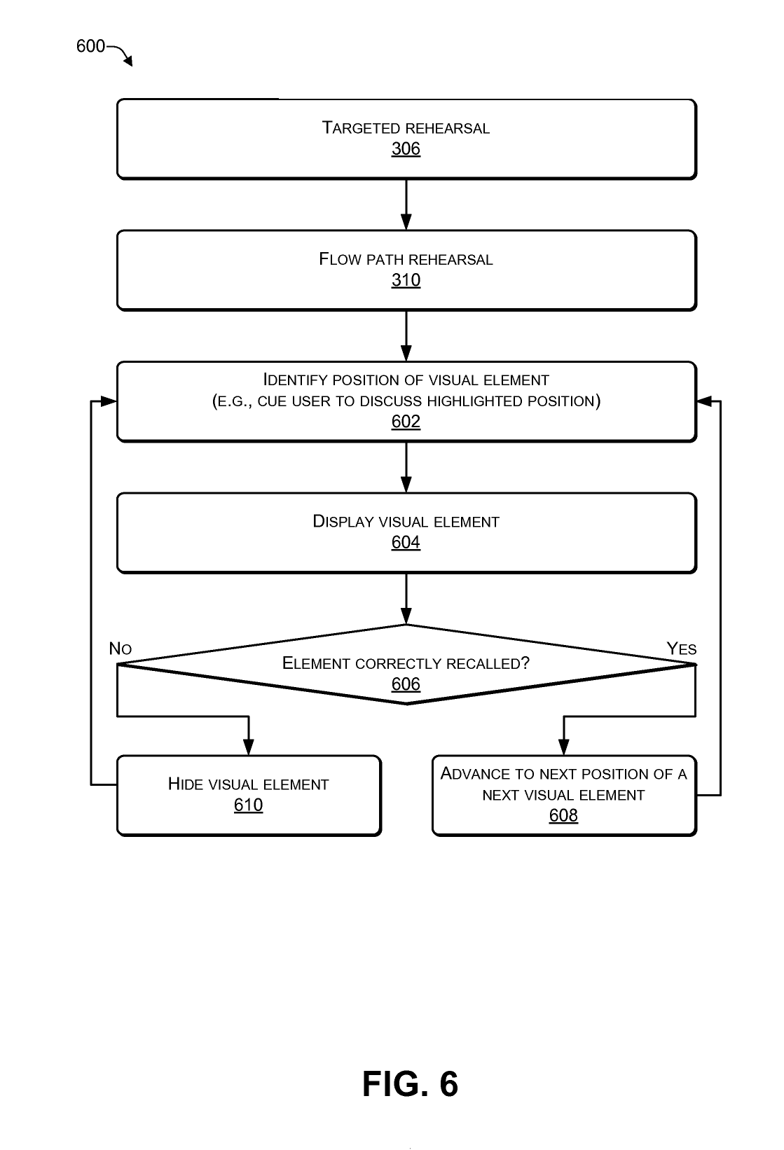

FIG. 6 is a flow diagram of an example process 600 that includes flow path rehearsal according to some implementations. The process 600 describes how a user may use a presentation authoring application (e.g., the modules 114, 116, and 118 of FIG. 1) to rehearse delivering talking points corresponding to visual elements. During extended authoring, the user may create flow paths, such as visual element flow paths that detail transitions between visual elements and slide flow paths that detail transitions between slides (e.g., between the current slide and a next slide).

During flow path rehearsal, the flow paths may be rehearsed. For example, visual elements may be hidden and later revealed to enable the user (e.g., presenter) to (a) determine whether the planned flow path (e.g., order) of the visual elements makes sense and (b) train the user to recall an order of the visual elements (e.g., which visual element comes after a current visual element). Flow path rehearsal may enable the user to deliver the presentation without constantly referring to the presentation, while building confidence that the user can deliver the presentation from memory if a problem (e.g., power failure, hardware failure, etc.) occurs or if an opportunity to speak about the topic arises outside of a formal presentation context (e.g., over dinner, at a chance meeting, etc.). In some cases, during presentation, the presenter may display a complete slide (e.g., showing all visual elements) to the audience, while viewing a private view (e.g., on a display device that is visible only to the presenter and/or a select audience). In this example, the private view may show only a current visual element (or a current visual element and past visual elements) but not future visual elements to be discussed/spoken to by the presenter. In some cases, the authoring presentation application may display a flow path view that shows the flow path and highlights a present location along the flow path so the presenter can see where the presenter is, and where to go next.

At 306, the user may enter targeted rehearsal mode and, at 310, the user may select flow path rehearsal. During flow path rehearsal, at 602, a position of a visual element may be identified (e.g., by displaying a bullet, a number, an underline, or other visual queue). The position of the visual element may be identified to cue the user to recall the visual element located at that position and the corresponding talking point and notes. For example, a partially filled slide may be displayed along with an indicator (bullet, number, . . . ) and a blank space where the visual element would appear were it not hidden.

At 604, the visual element may be displayed (e.g., revealed). For example, the visual element corresponding to the identified position may be displayed (1) automatically after a predetermined amount of time has passed (e.g., an amount of time entered by the user or estimated by the authoring application), (2) in response to the authoring application detecting a pause (e.g., by monitoring the microphone 122) during rehearsal, or (3) in response to user input indicating that the user has completed recalling the visual element. The visual element may be revealed to enable the user to determine whether the user correctly recalled the visual element located at the identified position.

At 606, a determination may be made whether the user was able to correctly recall the visual element. If the user was able to recall the visual element based on the identified position, then the identified position successfully cued (e.g., triggered) recall of the visual element. Repeatedly rehearsing using cued recall until the user can reliably recall the visual elements may improve the user's ability to remember what to say during delivery of the presentation to an audience.

If the user correctly recalled the visual element at the identified position, at 606, then the presentation may advance to a next position of a next visual element, at 608, and the process may repeat starting at 602, where the next position may be identified.

If the user was unable to correctly recall the visual element associated with the identified position, the user may continue practicing cued-recall. At 610, the visual element may be hidden and the process may be repeated by identifying the position of the visual element, at 602.

Thus, during flow path rehearsal, visual elements of a presentation may be hidden and their positions identified to cue the user to recall the visual elements located at the identified positions. If an identified position does not cause the user to recall the corresponding visual element, the user may (1) hide the visual element and practice recalling the visual element associated with the identified position, (2) proceed with recalling any remaining visual elements of a current slide and then repeat rehearsal of recalling the visual elements of the current slide, or (3) proceed with recalling any remaining visual elements of the presentation and then repeat rehearsal of recalling the visual elements of the presentation. In this way, flow path rehearsal may result in the user being able to recall visual elements in sequence during a presentation without having to rely on the visual elements being displayed.

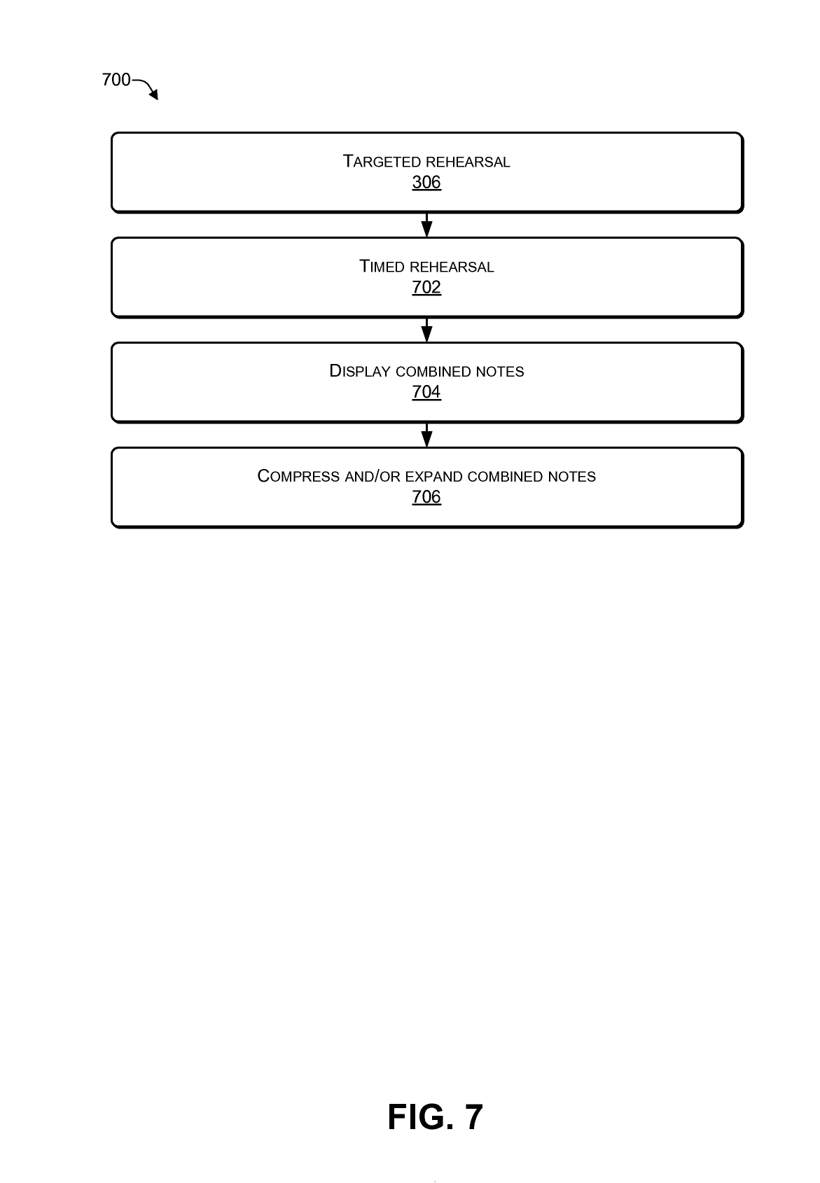

FIG. 7 is a flow diagram of an example process 700 that includes compressing and/or expanding notes according to some implementations. The process 700 describes how a user may use a presentation authoring application (e.g., one or more of the modules 114, 116, and 118 of FIG. 1) to time the rehearsal of a presentation.

At 306, the user may enter targeted rehearsal mode. At 702, the user may initiate timed rehearsal. During timed rehearsal, time targets set in the extended authoring phase (e.g., the extended authoring 306 of FIGS. 3 and 4) may be used to determine how long to speak about each visual element (e.g., based on the corresponding notes) and for how long.

At 704, notes or compressed notes may be displayed. For example, as described in the description of FIG. 2, during timed rehearsals, notes may be compressed by removing common words or phrases, removing different types of parts of speech according to a specific order, or both.

At 706, the notes may be compressed or expanded and the process of timed speech rehearsal may repeat, by proceeding to 702. For example, if the user is able to recall the notes during a rehearsal, the notes may be further compressed (e.g., by not displaying additional parts of speech) prior to a subsequent rehearsal, to cue the user to recall additional portions of the notes. If the user is unable to recall the notes during a rehearsal, the notes may be uncompressed (e.g., expanded) prior to a subsequent rehearsal. For example, the parts of speech that were removed in a previous compression may be restored. While two layers of compression are illustrated in FIG. 7, other implementations may enable more than two rounds of compression. The user may specify which notes are compressed and how the compression is performed (e.g., which parts of speech are removed in each round of compression). For example, a first part of speech may be removed in a first round of compression, a second part of speech may be removed in a second round of compression, and so on.

Thus, notes corresponding to visual elements may be compressed during each subsequent rehearsal to cue the user to recall a greater portion of the notes. If the user is unable to recall the compressed notes during rehearsal, the notes may be expanded to a previous level of compression prior to a subsequent rehearsal.

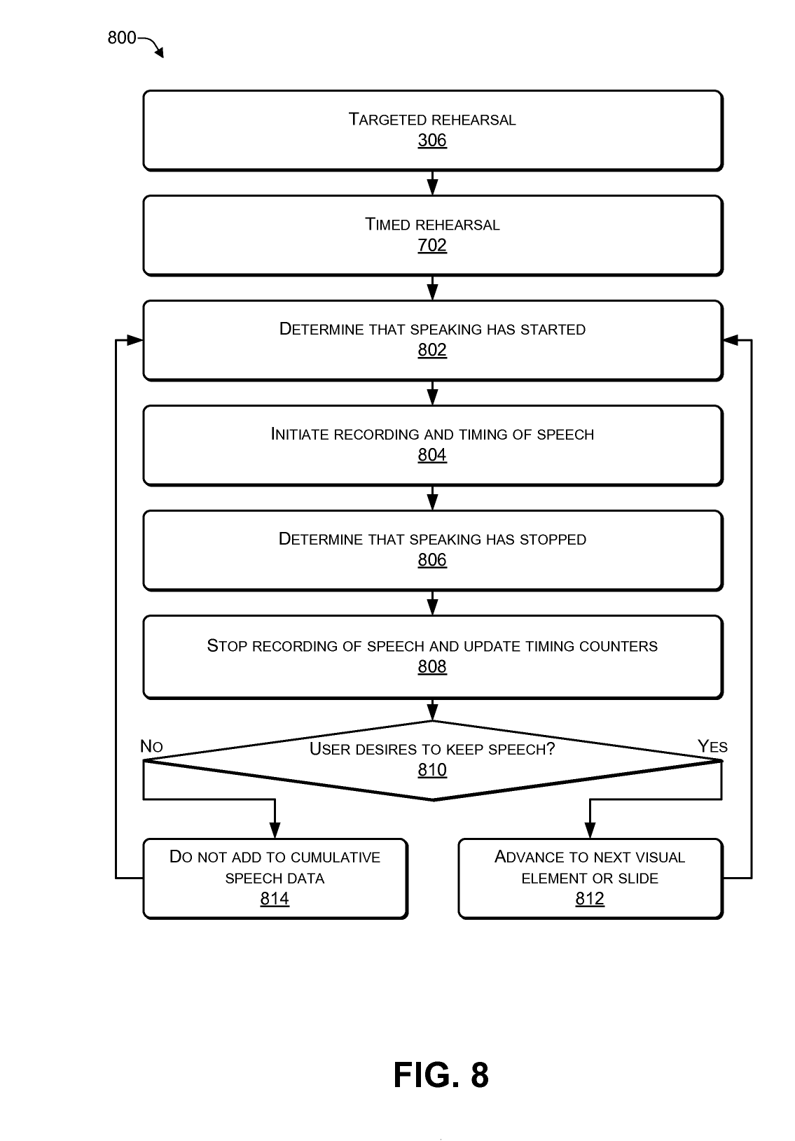

FIG. 8 is a flow diagram of an example process 800 that includes timed speech rehearsal according to some implementations. The process 800 describes how a user may use a presentation authoring application (e.g., one or more of the modules 114, 116, and 118 of FIG. 1) to time the rehearsal of a presentation.

At 306, the user may enter targeted rehearsal mode. At 702, the user may initiate timed rehearsal. For example, in FIG. 1, during timed rehearsal, the user may rehearse delivering various portions of the presentation 120 guided by predetermined time targets for the visual elements 132, the slides 124 to 126, and/or the presentation 120.

At 802, a determination may be made that the user has started speaking. At 804, recording and timing of the user's speech may be initiated. For example, in FIG. 1, during timed rehearsal, the timing module 118 may use automatic speech detection to determine when the user is speaking. To illustrate, the timing module 118 may monitor the audio data 144 received from the microphone 122 and determine when the user has initiated speaking (e.g., based on the monitoring). In response to determining that the user has begun speaking, the timing module 118 may initiate recording the speech by storing the audio data 144 received from the microphone 122 in the buffer 146.

At 806, a determination may be made that the user has stopped speaking. For example, in FIG. 1, the timing module 118 may monitor the audio data 144 received from the microphone 122 and determine when the user has stopped speaking.

At 808, the recording of the speech may be stopped and one or more timing counters may be updated. For example, in FIG. 1, the timing module 118 may, in response to determining that the audio data 144 does not include any speech data, determine that the user has stopped speaking and automatically stop the recording of the audio data 144. The timing module 118 may identify a speech data 148 portion of the audio data 144 and a non-speech data 150 portion of the audio data 144 and discard the non-speech data 150 portion of the audio data 144. The timing module 118 may determine a time associated with the speech data 148 portion of the audio data 144 and increment one or more timing counters, such as a visual element time counter identifying a time associated with discussing (e.g., speaking to) a highlighted visual element, a current slide time counter identifying a time associated with discussing a current slide, and/or a cumulative presentation time counter associated with a time to deliver the presentation up to a current point in time.

At 810, a determination may be made whether the user desires to keep the recorded speech. For example, in FIG. 1, after the timing module 118 has determined that the user has stopped speaking, the timing module 118 may display a prompt to determine whether the user desires to keep the most recently delivered speech.

If the user provides input indicating that the user desires to keep the speech, at 810, the process may advance to a next visual element or slide, at 812, and the process may proceed to 802 to determine when the user begins speaking. If the user provides input indicating that the user does not desire to keep the speech, at 810, the process may not add the most recent speech to the accumulated speech data, at 814, and the process may re-record the speech associated with the current (e.g., highlighted) visual element or current slide by proceeding to 802 to determine when the user begins speaking again. For example, in FIG. 1, if the user provides user input that the user is satisfied with the speech data 148, the speech data 148 may be added to the accumulated speech data 152. If the user provides user input that the user is dissatisfied with the speech data 148, the speech data 148 may not be added to the accumulated speech data 152 and additional audio data may be received to identify new speech data to add to the accumulated speech data 152.

Thus, during timed rehearsal, when the user speaks about a visual element or a slide, the audio data may be automatically recorded. If the user is satisfied with the delivery of the visual element or the slide, the speech data may be extracted from the audio data, and added to accumulated speech data. A time associated with the speech data may be determined and one or more time counters may be updated to include the time associated with the speech data.

### Example Computing Device and Environment

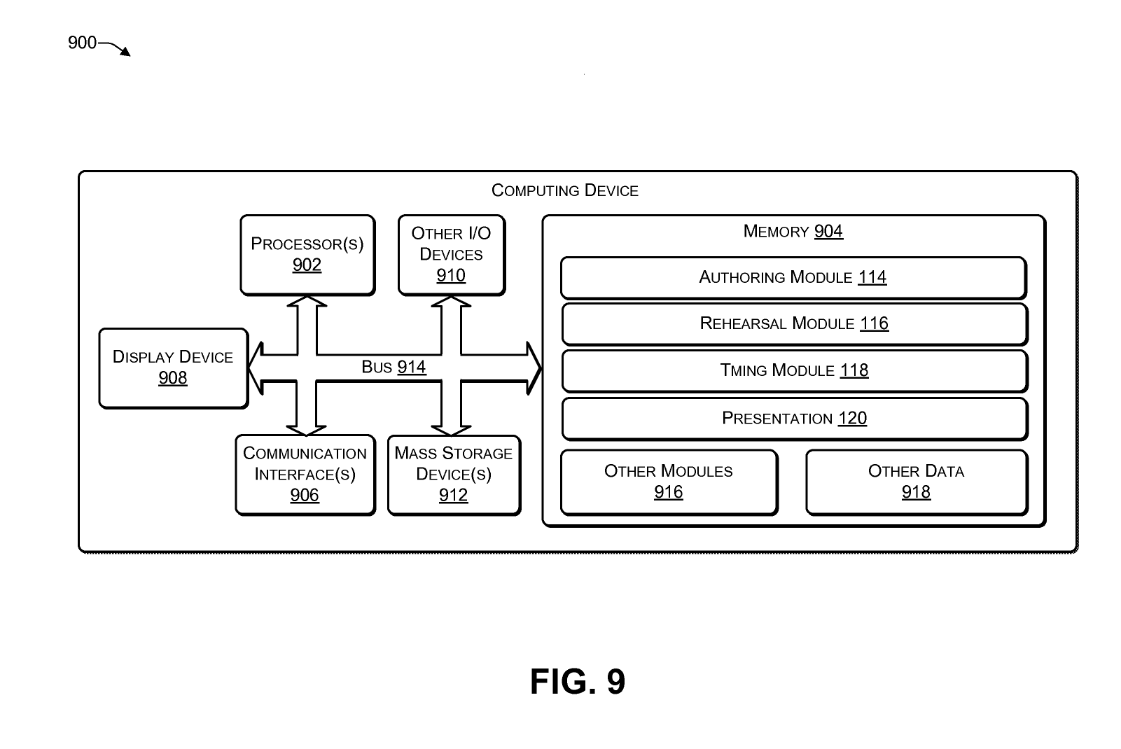

FIG. 9 illustrates an example configuration of a computing device 900 and environment that can be used to implement the modules and functions described herein. For example, the computing device 102 or the server 104 may include an architecture that is similar to or based on the computing device 900.

The computing device 900 may include one or more processors 902, a memory 904, communication interfaces 906, a display device 908, other input/output (I/O) devices 910, and one or more mass storage devices 912, able to communicate with each other, such as via a system bus 914 or other suitable connection.

The processor 902 may be a single processing unit or a number of processing units, all of which may include single or multiple computing units or multiple cores. The processor 902 may be implemented as one or more microprocessors, microcomputers, microcontrollers, digital signal processors, central processing units, state machines, logic circuitries, and/or any devices that manipulate signals based on operational instructions. Among other capabilities, the processor 902 may be configured to fetch and execute computer-readable instructions stored in the memory 904, mass storage devices 912, or other computer-readable media.

Memory 904 and mass storage devices 912 are examples of computer storage media for storing instructions, which are executed by the processor 902 to perform the various functions described above. For example, memory 904 may generally include both volatile memory and non-volatile memory (e.g., RAM, ROM, or the like). Further, mass storage devices 912 may generally include hard disk drives, solid-state drives, removable media, including external and removable drives, memory cards, flash memory, floppy disks, optical disks (e.g., CD, DVD), a storage array, a network attached storage, a storage area network, or the like. Both memory 904 and mass storage devices 912 may be collectively referred to as memory or computer storage media herein, and may be capable of storing computer-readable, processor-executable program instructions as computer program code that can be executed by the processor 902 as a particular machine configured for carrying out the operations and functions described in the implementations herein.

Although illustrated in FIG. 9 as being stored in memory 904 of computing device 900, the authoring module 114, the rehearsal module 116, the timing module 118, the presentation 120, other modules 916 and other data 918, or portions thereof, may be implemented using any form of computer-readable media that is accessible by the computing device 900. As used herein, “computer-readable media” includes computer storage media.

Computer storage media includes non-volatile, removable and non-removable media implemented in any method or technology for storage of information, such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium that can be used to store information for access by a computing device.

In contrast, communication media may embody computer readable instructions, data structures, program modules, or other data in a modulated data signal, such as a carrier wave. As defined herein, computer storage media does not include communication media.

The computing device 900 may also include one or more communication interfaces 906 for exchanging data with other devices, such as via a network, direct connection, or the like, as discussed above. The communication interfaces 906 can facilitate communications within a wide variety of networks and protocol types, including wired networks (e.g., LAN, cable, etc.) and wireless networks (e.g., WLAN, cellular, satellite, etc.), the Internet and the like. Communication interfaces 906 can also provide communication with external storage (not shown), such as in a storage array, network attached storage, storage area network, or the like.

A display device 908, such as a monitor may be included in some implementations for displaying information and images to users. Other I/O devices 910 may be devices that receive various inputs from a user and provide various outputs to the user, and may include a keyboard, a remote controller, a mouse, a printer, audio input/output devices, voice input, and so forth.

Memory 904 may include modules and components for training machine learning algorithms (e.g., PRFs) or for using trained machine learning algorithms according to the implementations described herein. The memory 904 may include multiple modules (e.g., the modules 114, 116, and 118) to perform various functions. The memory 904 may also include other modules 916 that implement other features and other data 918 that includes intermediate calculations and the like. The other modules 916 may include various software, such as an operating system, drivers, communication software, or the like.

The example systems and computing devices described herein are merely examples suitable for some implementations and are not intended to suggest any limitation as to the scope of use or functionality of the environments, architectures and frameworks that can implement the processes, components and features described herein. Thus, implementations herein are operational with numerous environments or architectures, and may be implemented in general purpose and special-purpose computing systems, or other devices having processing capability. Generally, any of the functions described with reference to the figures can be implemented using software, hardware (e.g., fixed logic circuitry) or a combination of these implementations. The term “module,” “mechanism” or “component” as used herein generally represents software, hardware, or a combination of software and hardware that can be configured to implement prescribed functions. For instance, in the case of a software implementation, the term “module,” “mechanism” or “component” can represent program code (and/or declarative-type instructions) that performs specified tasks or operations when executed on a processing device or devices (e.g., CPUs or processors). The program code can be stored in one or more computer-readable memory devices or other computer storage devices. Thus, the processes, components and modules described herein may be implemented by a computer program product.

Furthermore, this disclosure provides various example implementations, as described and as illustrated in the drawings. However, this disclosure is not limited to the implementations described and illustrated herein, but can extend to other implementations, as would be known or as would become known to those skilled in the art. Reference in the specification to “one implementation,” “this implementation,” “these implementations” or “some implementations” means that a particular feature, structure, or characteristic described is included in at least one implementation, and the appearances of these phrases in various places in the specification are not necessarily all referring to the same implementation.

### CONCLUSION

Although the subject matter has been described in language specific to structural features and/or methodological acts, the subject matter defined in the appended claims is not limited to the specific features or acts described above. Rather, the specific features and acts described above are disclosed as example forms of implementing the claims. This disclosure is intended to cover any and all adaptations or variations of the disclosed implementations, and the following claims should not be construed to be limited to the specific implementations disclosed in the specification. Instead, the scope of this document is to be determined entirely by the following claims, along with the full range of equivalents to which such claims are entitled.

What is claimed is:

1. A method performed by one or more processors executing instructions to perform acts comprising:
receiving presentation input to create a presentation comprised of multiple slides, each slide having one or more visual elements;
creating one or more notes sections, each of the one or more notes sections corresponding to one of the one or more visual elements; and
receiving time targets associated with each of the one or more visual elements.

2. The method as recited in claim 1, the acts further comprising:
receiving order input identifying a speaking order for the one or more visual elements in a slide of the multiple slides; and
arranging an order of the one or more visual elements and the corresponding one or more notes sections in the slide based on the speaking order.

3. The method as recited in claim 2, before receiving the order input the acts further comprising:
overlaying a visual flow path of the one or more visual elements on the slide;
receiving flow path input to rearrange an order of one or more nodes in the flow path, the one or more nodes corresponding to the one or more visual elements;
rearranging the order of the one or more nodes in the flow path based on the flow path input.

4. The method as recited in claim 1, the acts further comprising:
determining a number of words in each of the one or more notes sections; and
in response to determining that a particular notes section of the one or more notes sections includes one or more words:
determining a frequency with which each word of the one or more words occurs in the particular notes section; and
determining a part of speech associated with each word of the one or more words.

5. The method as recited in claim 4, the acts further comprising:
compressing the one or words based at least partly on:
the frequency with which each word of the one or more words occurs in the particular notes section; and
the part of speech associated with each word of the one or more words.

6. The method as recited in claim 1, the acts further comprising:
entering a rehearsal mode;
highlighting a visual element of the corresponding notes section; and
after a predetermined period of time has elapsed, highlighting a next visual element and removing highlighting of the visual element, the predetermined period of time comprising one of the time targets.

7. A computing device comprising:
one or more processors;
one or more computer-readable storage media storing instructions executable by the one or more processors to perform acts comprising:
creating a presentation comprised of multiple slides, each slide of the multiple slides having one or more visual elements;
creating a notes section for at least one visual element of the one or more visual elements; and
determining a period of time corresponding to each of the one or more visual elements, the period of time identifying a time to display a corresponding visual element before displaying a next visual element of the one or more visual elements.

8. The computing device as recited in claim 7, the acts further comprising:
identifying, on a slide of the multiple slides, a first location of a first visual element of the one or more visual elements; and
after the period of time corresponding to the first visual has elapsed, identifying a second location of a second visual element on the slide to cue recall of the second visual element and the corresponding notes section.

9. The computing device as recited in claim 8, wherein, during the rehearsal of the delivery of the presentation, the acts further comprise:
receiving audio data from a microphone;
identifying speech data and non-speech data in the audio data; and
discarding the non-speech data.

10. The computing device as recited in claim 9, the acts further comprising:
determining a length of time associated with the speech data; and
updating one or more timing counters associated with the rehearsal of the delivery of the presentation based on the length of time associated with the speech data.

11. The computing device as recited in claim 10, wherein the one of more timing counters comprise one or more of:
a presentation timing counter associated with the rehearsal of the delivery of the presentation,
a visual element timing counter associated with delivery of a particular visual element of the one or more visual elements and the corresponding notes section; and
a slide timing counter associated with delivery of a particular slide of the multiple slides.

12. The computing device as recited in claim 7, the acts further comprising:
compressing the notes sections for the at least one visual element before a subsequent rehearsal based at least partly on:
a frequency of occurrence of words in the notes section corresponding to each visual element, and
a part of speech associated with each of the words.

13. One of more computer-readable storage media including instructions that are executable by one or more processors to perform acts comprising:
creating a presentation comprised of multiple slides, each slide having one or more visual elements, each visual element of the one or more visual elements comprising at least one of text or a graphical image;
creating a notes section corresponding to each of the one or more visual elements, the notes section including details associated with each of the one or more visual elements;
determining one or more periods of time, each of the one or more periods of time corresponding to each of the one or more visual elements; and
entering a rehearsal mode in which portions of the presentation are displayed in turn based on the one or more periods of times; and
displaying a current slide of the multiple slides.

14. The one of more computer-readable storage media as recited in claim 13, the acts further comprising:
highlighting a first visual element of the current slide corresponding to a first notes section;
recording first audio data that is received in response to highlighting the first visual element;
identifying first speech data from the first audio data; and
adding the first speech data to accumulated speech data that is associated with the presentation.

15. The one of more computer-readable storage media as recited in claim 14, the acts further comprising:
highlighting a second visual element of the current slide;
recording second audio data that is created in response to highlighting the second visual element;
identifying second speech data from the second audio data; and
adding the second speech data to the accumulated speech data.

16. The one of more computer-readable storage media as recited in claim 15, wherein, before highlighting the first visual element of the current slide, the acts further comprise:
removing a portion of words included in the corresponding first notes section, the portion removed based on a frequency of each of the words in the first notes section and a part of speech of each of the words in the first notes section.

17. The one of more computer-readable storage media as recited in claim 13, the acts further comprising:
identifying a first position of a first visual element of the current slide;
recording first audio data that is received in response to identifying the first portions of the first visual element;
identifying first speech data included in the first audio data; and
adding the first speech data to accumulated speech data that is associated with the presentation.

18. The one of more computer-readable storage media as recited in claim 17, the acts further comprising:
identifying a second position of a second visual element of the current slide;
recording second audio data associated with the second visual element;
identifying second speech data included in the second audio data; and
adding the second speech data to the accumulated speech data.

19. The one of more computer-readable storage media as recited in claim 17, the acts further comprising:
determining a first time associated with the first speech data; and
updating at least one of:
a visual element timing counter associated with delivering the first visual element and the corresponding notes section; and
a slide timing counter associated with a time to deliver the current slide.

20. The one of more computer-readable storage media as recited in claim 17, the acts further comprising:
determining a cumulative time associated with the accumulated speech data; and
updating a presentation timing counter associated with a time to deliver the presentation based on the cumulative time.
